(19) United States
(12) Patent Application Publication
(10) Pub. No.: US 2014/0251709 A1
(43) Pub. Date: Sep. 11, 2014

(54) VEHICLE HAVING A PEDAL DRIVE AND A REVERSE GEAR MECHANISM

(71) Applicant: Kurt Ruffieux, Thalwil (CH)

(72) Inventor: Kurt Ruffieux, Thalwil (CH)

(73) Assignee: SYNERGY BIOSURGICAL AG, Zug (CH)

(21) Appl. No.: 14/239,436

(22) PCT Filed: Aug. 17, 2011
(86) PCT No.: PCT/CH2011/000183

§ 371 Date: May 2, 2014

(51) Int. Cl. B62M 1/36; B62M 6/45; B62M 6/50; B62M 6/40

(52) U.S. Cl. CPC B62M 1/36; B62M 6/40; B62M 6/45; B62M 6/50
USPC 180/206.3; 280/237; 180/206.1; 180/206.2

(57) ABSTRACT

A vehicle that includes a vehicle frame having a steering device, a first vehicle wheel fastened to the steering device, one or more second vehicle wheels fastened to the vehicle frame, a braking device, and a drive device having a pedal crank that can be driven by pedals. The vehicle further includes a freewheel clutch and an optionally engageable reverse gear mechanism. When the freewheel clutch is in an engaged state in a drive mode during the forward movement of the pedals, force is transmitted from the drive device to at least the second vehicle wheel. The freewheel clutch can be switched from the drive mode into a braking mode when the reverse gear mechanism is in the engaged state so that, in the braking mode, the pedal crank and the at least one second vehicle wheel are connected to each other in a torsionally rigid manner.

The invention relates to vehicle with a pedal drive and a reverse gear mechanism in accordance with the generic part of claim 1 and to a method for eccentric muscle training with a vehicle in accordance with the invention and in accordance with the generic part of claim 26.

Bicycles are usually driven by pedals that are stepped on with the feet. For a forward movement the pedals are usually stepped on in a forward manner, which brings about an optimal loading of the joints and of the musculature. During reverse travel the pedals can stop and a freewheel mechanism allows the wheels to roll freely without the pedals also rotating. Brake cheeks, drum brakes, disk brakes or other energy-converting mechanisms are used as brakes via a hand lever or a back-pedaling mechanism.

A bicycle drive with a reverse gear mechanism is known from U.S. Pat. No. 7,445,223 HONG, whereby it can be achieved by engaging and disengaging the reverse gear mechanism that the bicycle moves forward when the pedals are driven in a forward or backwardly directed direction of rotation. The reverse gear mechanism is arranged on the pedal shaft support. During the forward rotation of the pedal shaft torque exerted via the pedals is transferred by a first one-way clutch onto the chain wheel so that the rear wheel rotates forward whereas when the reverse gear mechanism is engaged during reverse rotation of the pedal shaft the torque exerted via the pedals is transferred by a second one-way clutch via a planet wheel transmission onto the chain wheel so that the rear wheel also rotates forward. As a result of the fact that both one-way clutches transfer a torque only from the pedal shaft onto the chain wheel and a torque is not transmitted from the rear wheel onto the pedal shaft in both instances by the two one-way clutches, no braking action can be exerted on the rear wheel by rotating the pedal shaft backwards when the bicycle is traveling downhill.

However, there are biomechanical sport-physiological aspects that allow an active breaking of the travel by the musculature (so-called “eccentric training”) to appear to be attractive. However this is not possible in an appropriate manner with bicycles of the current state of the art.

The invention would like to find a solution here. The invention has the basic problem of creating a vehicle with pedal drive and with a reverse gear mechanism for eccentric training.

Eccentric muscle work is very important in very many daily activities and in sport, e.g., during braking movements during a landing, during skiing or during hiking in the mountains. The amount of eccentric muscle work is also great during jogging. Every time a foot is put down the muscle-tendon system is elastically expanded like a spring. During the immediately following pushing off of the leg this elastic spring energy contributes up to 50 percent of the forward thrust performance. Many running or hopping animals also make use of this property.

The invention solves the problem posed with a vehicle with pedal drive and a reverse gear mechanism that has the features of claim 1 and with a method for eccentric muscle training with a vehicle in accordance with the invention and in accordance with claim 26.

The advantages achieved by the invention are substantially to be seen in that by virtue of the device in accordance with the invention:
the muscles are expanded against their resistance, loaded and trained in a way different than in concentric training. Advantages of this reversal of movement reside in an oxygen consumption that is reduced by a factor of 5 with the same work and with the same or even increased muscle buildup. The muscles and joints are loaded during the braking movement with the same force vectors as in the active forward movement of the bicycle but in the opposite direction of movement of the muscles (i.e., e.g., pedals and feet rotate in a braking manner backwards while, e.g., the vehicle is rolling forward downhill). This also proved to be advantageous for the loading of the joints, since in this manner the optimal loading conditions for muscles and joints are achieved; and
the movement apparatus (muscles, tendons, ligaments, bones and joints) is loaded in a super-proportional manner in comparison to the circulatory system. The energy consumption and therefore the load on the circulatory system is clearly less in the case of eccentric muscle work than in a comparable, concentric loading.

In the drive mode of the vehicle, i.e. when the reverse gear mechanism, is disengaged, the vehicle can be driven in the traditional manner whereas when the reverse gear mechanism is engaged, i.e., in the brake mode during a forward movement of the vehicle caused by downhill travel or an electrodrive a transfer of force takes place from the forward-rotating rear wheel onto the pedal shaft that is rotating in the opposite direction, i.e., backwards, so that the vehicle can be eccentrically braked with muscle power. The goal is not the activation of a brake but rather the transfer of the movement onto pedals or e.g., movable levers whose active, eccentric braking brings about a slowing of the travel. Since the pedal crank and the second vehicle wheel are connected in a torsionally rigid manner in both directions of rotation when the freewheel clutch has been shifted, the vehicle can also be driven in the forward direction when the reverse gear mechanism is engaged by pedaling backwards on the pedals. For example, it can occasionally be pleasant when bicycling to pedal backwards on the pedals in an actively concentric manner in order to move forward, e.g., over small inclines.

Other advantageous embodiments of the invention can be commented on as follows:

In a special embodiment of the vehicle the freewheel clutch can be blocked or bridged in the brake mode.

In another embodiment of the invention the braking device comprises a brake lever, whereby when the brake lever is activated the freewheel clutch can be shifted from the brake mode into the drive mode. This can achieve the advantage that if the driving force transferred from the rear wheel onto the pedals becomes too great in the brake mode during downhill travel, the freewheel clutch can be shifted into the drive mode by activating the brake lever so that the freewheel clutch is in neutral when the rear wheel is rotating forward. As a result of this safety mechanism the bicycle is switched when the braking force is too great to an operation like that in a traditional bicycle.

In another embodiment of the vehicle it comprises an automatic overload safety by means of which the freewheel clutch can be shifted from the brake mode into the drive mode and the reverse gear mechanism can preferably be disengaged. This embodiment makes the advantage possible that during the actuation of the overload safety, e.g., of a centrifugal control, the freewheel clutch is switched into the drive mode and the driving force is no longer transferred from the rear wheel and the bicycle can roll downhill without the pedals also rotating.

In yet another embodiment of the vehicle it comprises a clutch. As a consequence, during downhill travel an engaging of the brake mode without impact forces becomes possible. The clutch can be constructed as a clutch that can be engaged and disengaged or as an elastic, non-switchable clutch and can be arranged, e.g., in the reverse gear mechanism.

In another embodiment of the vehicle the reverse gear mechanism comprises an intermediate wheel that can be engaged and disengaged.

In another embodiment of the vehicle the reverse gear mechanism comprises a second chain or a second belt that is crossed between the pedal crank and the second vehicle wheel.

In yet another embodiment of the vehicle the reverse gear mechanism comprises a planet wheel transmission.

In another embodiment the vehicle comprises a brake-idling system that can be activated when the reverse gear mechanism is engaged and that brings about alternating braking-and idling modes of the pedal crank in the braking mode. The braking/idling system can be designed as blocking-and idling modes that alternate in rapid succession, e.g., clamping movements and releasing movements, which results in a shaking of the pedals during the loading by breaking (shaking mechanism).

In another embodiment of the vehicle the drive device or the reverse gear mechanism comprises a translation. This can achieve the advantage that the driver can engage a certain gear before the downhill travel and the eccentric training and can adapt to the approaching slope in this manner. In order that an approximately uniform torque can be achieved in the case of a different inclination of the road, changing translation conditions are needed in the transfer of force from the pedal crank onto the rear shaft. This also applies to the transfer of the braking force in the reverse direction.

In another embodiment of the vehicle the reverse gear mechanism is arranged on the pedal crank.

In yet another embodiment of the vehicle the reverse gear mechanism can be integrated into the at least one second vehicle wheel.

The reverse gear mechanism preferably comprises a first shaft with a longitudinal axis, drive means that comprise one or more chain wheels, belt wheels or elements of a Cardan drive, and comprises a second shaft that is constructed as a hollow shaft arranged concentrically around the first shaft, whereby the reverse gear mechanism is arranged between the first and the second shaft so that when the reverse gear mechanism is engaged an oppositely directed direction of rotation is produced between the first and the second shaft and when the reverse gear mechanism is disengaged a direction of rotation in the same direction is produced between the first and the second shaft.

In another embodiment of the vehicle the first shaft is constructed as a hollow shaft and can be built into the at least one second vehicle wheel. This can achieve the advantage that the first shaft can be mounted on the axle of a bicycle rear wheel. The entire reverse gear mechanism can be fixed on the rear wheel fork of a vehicle frame via such a commercially axle, e.g., with quick-action chucks.

In another embodiment the vehicle comprises a measuring device for measuring the braking performance in the brake mode and preferably comprises a microcomputer. The measuring device can be built in, for example, in the rear wheel hub of the vehicle. With a computer that is also built-in and a pulse measuring carried out at the same time the vehicle can also be used therapeutically or for performance sport.

In yet another embodiment the vehicle comprises a switching device for cutting the reverse gear mechanism in and out.

In another embodiment of the vehicle the freewheel clutch can be switched by a second switching device from the drive mode into a braking mode.

In another embodiment the vehicle comprises an activation device with which the first and the second switching device can be activated.

In another embodiment the vehicle comprises an electrodrive with which the vehicle can be driven in the forward direction.

In yet another embodiment of the vehicle the electrodrive comprises a programmable microcomputer with which the driving force and/or the speed of the electrodrive can be adjusted. The advantages can be achieved with this that, for example, loading patterns can be programmed for training purposes, for the diagnosis or for therapy. Furthermore, it is made possible that the more a training person brakes in the braking mode, i.e., trains eccentrically, the more rapidly the bicycle is driven by the electrodrive, as a result of which a motivating effect can be achieved.

In another embodiment the vehicle comprises a power sensor by means of which the drive power of the electrodrive can be regulated. Therefore, at a certain selected speed the drive performance can be adapted to the requirements of the user.

In another embodiment of the vehicle the electromotor can also be operated as a generator.

In another embodiment of the vehicle an additional motor/generator group is arranged on the second vehicle wheel. This can achieve the advantage that there are two mechanically separate functional groups. The first one is connected to the pedal support and therefore in direct mechanical contact with the driver. The motor in the pedal support can also be operated as a generator. A motor/generator group also sits in the rear wheel hub. The connection between the two functional groups is an electric storage/battery accumulator. During braking the motor (in the pedal support) drives the bicycle and draws energy from the battery accumulator. In the drive mode the motor acts as a generator and feeds the battery accumulator. Exactly the same applies to the functional group on the rear wheel. As a result of the mechanical decoupling of the two functional groups the system is very variable.

The vehicle in accordance with the invention is preferably used for eccentric muscle training.

Other preferred usages of the vehicle in accordance with the invention are its use in diagnosing methods and/or therapy methods, in particular in the rehabilitation training of cardiac patients. The advantage of these usages of the vehicle in accordance with the invention is that the energy consumption and therefore the circulatory load during eccentric muscle work is clearly less than in the case of comparable concentric loading. The movement apparatus (muscles, tendons, ligaments, bones and joints) is loaded in a super-proportional manner in comparison to the circulatory system. This property can be utilized, for example, in the rehabilitation training of cardiac patients.

In a special embodiment of the method the drive of the vehicle in the forward direction takes place by downhill travel.

In another embodiment of the method the drive of the vehicle in the forward direction can take place alone or additionally by an electromotor.

The invention and further developments of the invention are explained in more detail in the following using partially schematic representations of several exemplary embodiments.

In the figures:

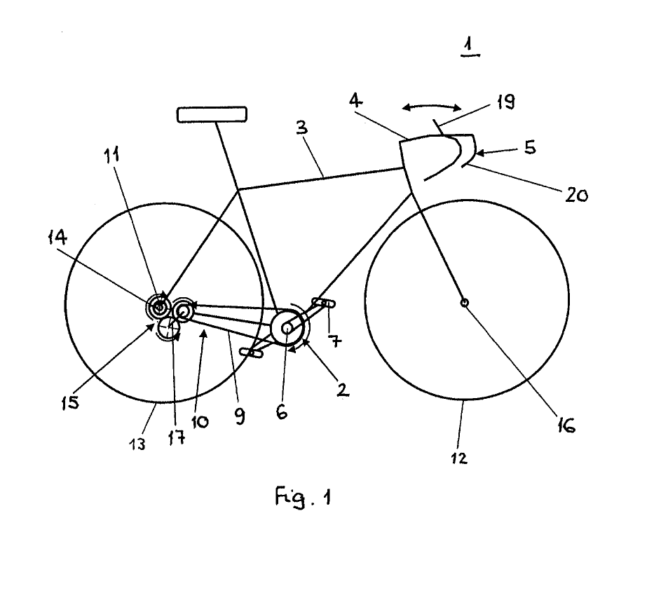

FIG. 1 shows a view of an embodiment of the vehicle in accordance with the invention;

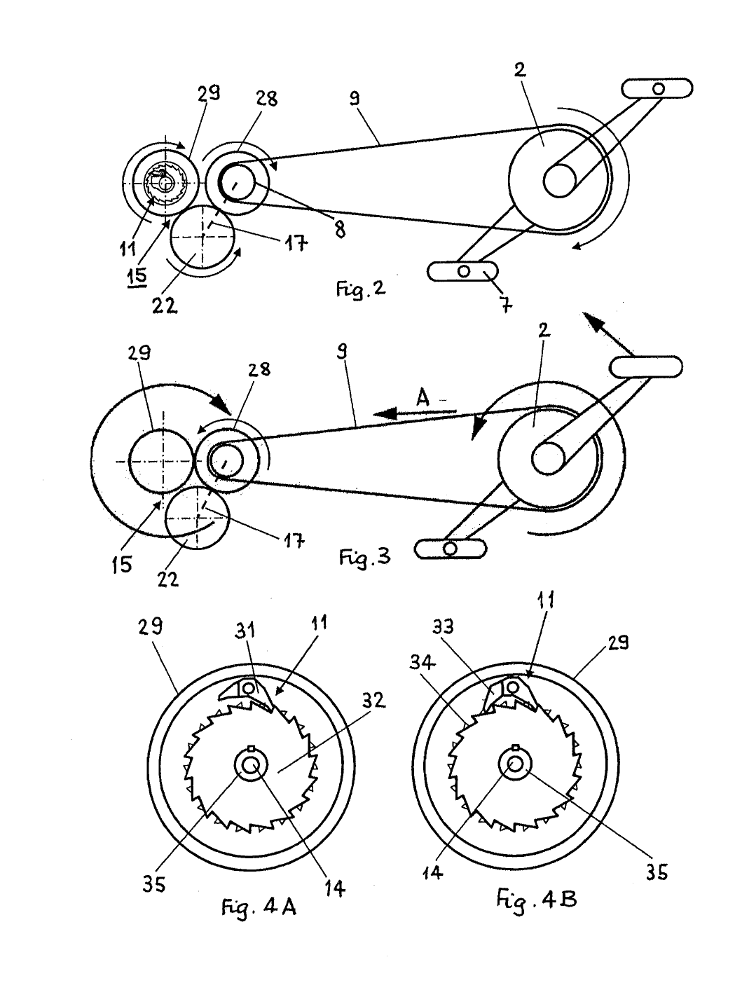

FIG. 2 shows an enlarged section of the drive device of the embodiment of the vehicle in accordance with the invention mode shown in FIG. 1 in the drive mode;

FIG. 3 shows an enlarged section of the drive device of the embodiment of the vehicle in accordance with the invention shown in FIG. 1 in the braking mode;

FIG. 4A shows an enlarged view of the freewheel clutch of the embodiment of the vehicle in accordance with the invention shown in FIG. 1 in the drive mode;

FIG. 4B shows an enlarged view of the freewheel clutch of the embodiment of the vehicle in accordance with the invention shown in FIG. 1 in the braking mode;

FIG. 5 shows an enlarged view of the drive device of another embodiment of the vehicle in accordance with the invention;

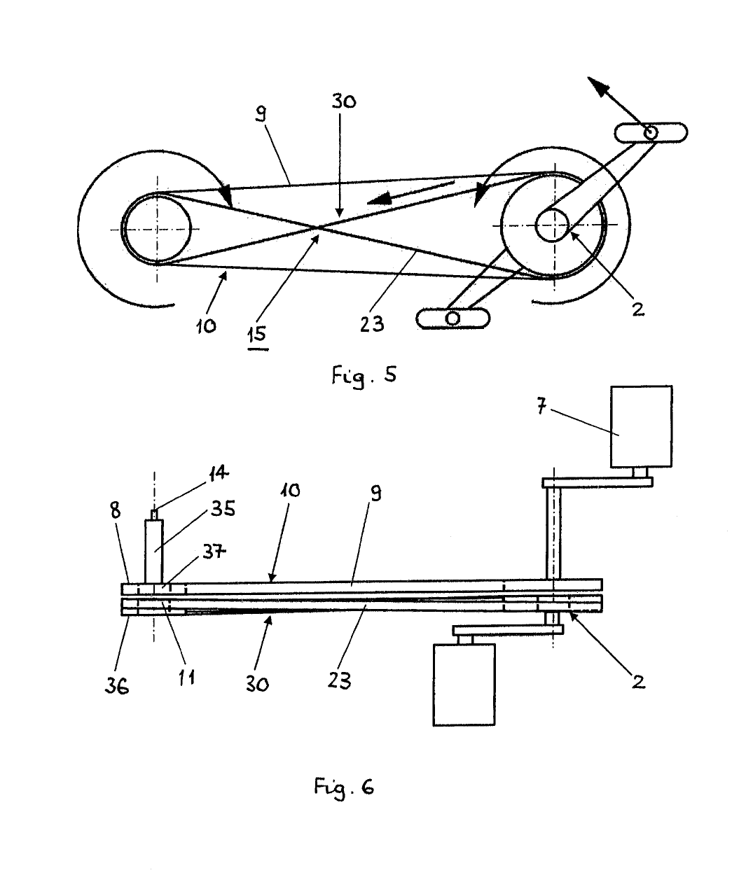

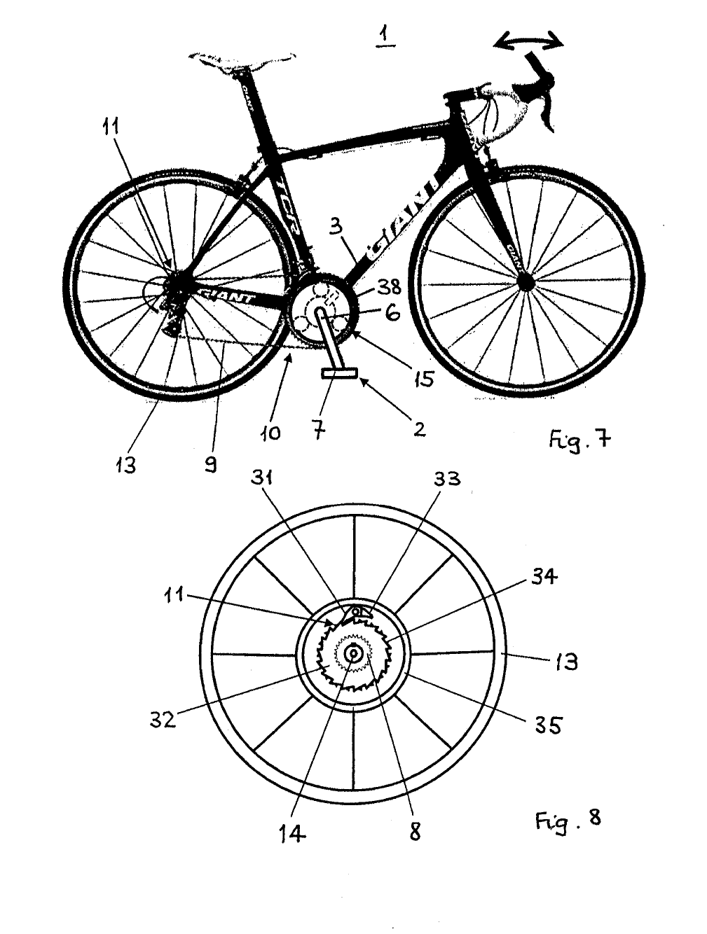

FIG. 6 shows a top view onto the section of the drive device shown in FIG. 5;

FIG. 7 shows a view of another embodiment of the vehicle in accordance with the invention;

FIG. 8 shows an enlarged view of the freewheel clutch of the embodiment of the vehicle in accordance with the invention shown in FIG. 7; and

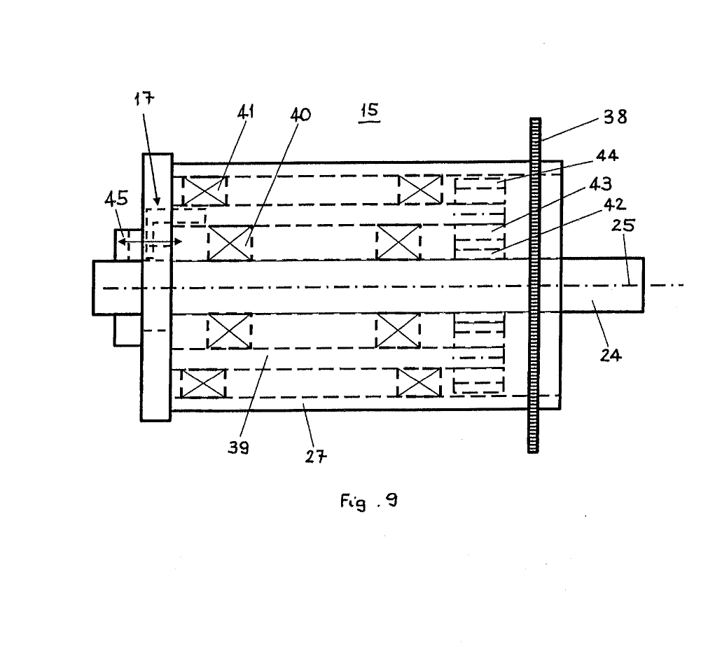

FIG. 9 shows a view onto the reverse gear mechanism of the embodiment of the vehicle in accordance with the invention shown in FIG. 7.

The embodiment of the vehicle 1 in accordance with the invention, with pedal drive 2 and shown in the FIGS. 1 to 4 is constructed as a bicycle and comprises substantially a vehicle frame 3 with a steering device 4, a first and a second vehicle wheel 12; 13, a braking device 5, a drive device 10, a blockable freewheel clutch 11 and a reverse gear mechanism 15 that can be engaged and disengaged.

The first vehicle wheel 12 is constructed as a front wheel and fastened to the steering device 4 by a first wheel axis 16 while the second vehicle wheel 13 is constructed as a rear wheel and is fastened to the vehicle frame 3 by at least one second wheel axle 14.

The drive device 10 comprises a pedal crank 6 that can be driven by pedals 7 and comprises a chain drive 9 arranged between the pedal crank 6 and the second vehicle wheel 13. Alternatively, a belt drive or a Cardan drive can be arranged between the pedal crank.

In addition, the vehicle 1 comprises a freewheel clutch 11 that is arranged on the second wheel axle 14 and is in a coupled-in state in a drive mode in a forward drive of the pedals 7 so that a transfer of force from the drive device 10 onto the second vehicle wheel 13 can be carried out.

Furthermore, the vehicle 1 comprises a reverse gear mechanism 15 that can be engaged and disengaged and is attached in the area of the second vehicle wheel 13 to the vehicle frame 3. When the reverse gear mechanism 15 is engaged, an oppositely directed direction of rotation can be produced between the second vehicle wheel 13 and the pedal crank 6 (FIG. 3).

The freewheel clutch is blocked during the engaging of the reverse gear mechanism 15 from the drive mode into a braking mode so that in the braking mode the pedal crank 6 and the at least one second vehicle wheel 13 are connected to each other in a torsionally rigid manner.

The vehicle 1 comprises a switching device 17 for cutting the reverse gear mechanism 15 in and out, whereby the switching device 17 can be operated in this embodiment by a activation device 19 arranged on the steering device 4.

The reverse gear mechanism 15 comprises a first gear 28 connected in a torsionally rigid manner to the rear chain wheel 8 (FIG. 2) of the drive device 10, comprises a second gear 29 connected to the freewheel clutch 11 (FIG. 4) and comprises an intermediate gear 22.

In the drive mode (FIG. 2), i.e., with the reverse gear mechanism 14 disengaged, the first gear 28 and the intermediate gear 22 are positioned in such a manner relative to the second gear 29 that the first gear is in engagement only with the intermediate gear 22 and the intermediate gear 22 is in engagement with the first gear 28 and the second gear 29. The first gear 28 is driven forward via the chain drive 9 by the pedal drive 2 driven by the pedals 7 in the forward direction of the vehicle 1 so that in the drive mode, i.e., with the reverse gear mechanism 15 disengaged the intermediate gear 22 engaged with the first gear 28 is driven in the opposingly directed direction of rotation and the second gear 29 engaged with the intermediate gear 22 is again driven in the same direction to the first gear 28, i.e., in the forward direction of the vehicle 1. The freewheel clutch 11 comprises a first catch 31 that is in engagement with the first locking gear 32 in the drive mode when the second gear 29 is rotating forward, so that a transfer of force takes place in the forward direction from the second gear 29 onto the wheel hub 35 rotatably supported on the second wheel axle 14 (FIG. 4A).

In the braking mode (FIG. 3), i.e., with the reverse gear mechanism 15 engaged, the first gear 28 and the intermediate gear 22 are positioned in such a manner to the second gear 29 by the switching device 17 that the first gear 28 is engaged with the second gear 29 and that the intermediate gear 22 is engaged only with the first gear 28. In the braking mode the freewheel clutch 11 is blocked (FIG. 4B), which takes place by a second catch 33 engaging into a second locking gear 34. When the second catch 33 is engaged with the second locking gear 34 a transfer of force takes place from the second vehicle wheel 13 via the wheel hub 35 rotatably supported on the second wheel axle 14 onto the second gear 29 in the forward direction, which would not be transferred by a freewheel clutch customary in trade. The first gear 28, that is engaged with the second gear 29, is driven by the second gear 29 that is driven in the forward direction, e.g., during downhill travel, in the oppositely directed direction, i.e., in the backward direction, so that a tractive force is exerted on the chain drive 9 in the direction of the arrow A in FIG. 3. The pedal drive 2 is consequently also driven in the backward direction by the chain drive 9 so that an eccentric braking force can be exerted on the pedals 7 by the driver. A coupling, e.g., a rubber coupling, that can be engaged and disengaged or is rotationally elastic can be inserted between the wheel hub 35 supported on the second wheel axle 14 and the second locking gear 34 so that any impact forces occurring during the engaging of the braking mode can be damped.

The brake device 5 comprises a brake lever 20 that is connected to the rear wheel brake and with which only the rear wheel brake is operated in the drive mode, and in the brake mode the freewheel clutch 11 is switched from the braking mode, that is, from the blocked state into the drive mode, i.e., unblocked upon an activation of the brake lever 20.

FIGS. 5 and 6 show a reverse gear mechanism 15 of another embodiment of the vehicle 1 in accordance with the invention. The reverse gear mechanism 15 comprises a second chain drive 30 with a second chain 23 that is arranged in a plane parallel to the chain drive 9 of the drive device 10. The second chain 23 is crossed between the pedal crank 6 and the wheel hub 35 of the second vehicle wheel 13, which hub can rotate on the second wheel axle 14. The blockable freewheel clutch 11 is arranged between the wheel hub 35 and the second rear chain wheel 36 that belongs to the second chain drive 30 so that in the drive mode, i.e., when the reverse gear mechanism 15 is disengaged no transfer of force takes place between the second rear chain wheel 36 and the wheel hub 35. A commercial freewheel clutch 37 is arranged on the rear chain wheel 8 of the chain drive 9 of the drive device 10, which functions as a drive device for driving the vehicle 1 forward by the pedal drive 2. In the braking mode, i.e., when the reverse gear mechanism 15 is engaged, the blockable freewheel clutch 11 is blocked between the wheel hub 35 and the second rear chain wheel 36 of the second chain drive 30 so that a transfer of force takes place, e.g., during downhill travel, from the wheel hub 35 are arranged on the rear wheel onto the second chain drive 30 and as a consequence of the crossed second chain 23 the pedals 7 of the pedal drive 2 are driven in the backward direction. The chain drive 9 of the drive device 10 is not driven by the rear wheel in the braking mode on account of the commercial freewheel 37.

FIGS. 7 to 9 show another embodiment of the vehicle 1 in accordance with the invention that differs from the embodiment shown in FIGS. 1 to 4 only in that the reverse gear mechanism 15 is constructed as a planet wheel transmission. The reverse gear mechanism 15 is arranged on the pedal drive 2 between the pedal crank 6 and the front chain wheel 38. The freewheel clutch is arranged between the chain wheels 8 of the drive device 10 constructed as chain drive 9 and between the wheel hub 35 that is rotatably arranged on the second wheel axle 14 and connected in a torsionally rigid manner to the second vehicle wheel 13.

The freewheel clutch 11 comprises a first catch 31 that is in engagement with the first locking gear 32 in the drive mode when chain wheel 8 is rotating forward so that a transfer of force takes place in the forward direction of rotation from the chain wheel 8 to the wheel hub 35 rotatably supported on the wheel axle 14.

In the braking mode the freewheel clutch 11 is blocked, which takes place by a second catch 33 engaging in a second locking gear 34. When the second catch 33 is engaged with the second locking gear 34 a transfer of force takes place from the second vehicle wheel 13 via the wheel hub 35 rotatably supported on the second wheel axle 14 onto the chain wheel 8 in the forward direction. The front chain wheel 38, which chain wheel 38 is engaged via the chain with chain wheel 8, is driven by the chain wheel 8 driven in the forward direction, e.g., during downhill travel, on the pedal drive 2 in the same direction, i.e., in the forward direction.

As FIG. 9 shows, the reverse gear mechanism 15 comprises a first shaft 24 firmly connected to the pedal crank 6 and with a longitudinal axis 25 and a second shaft 27 that is constructed as a hollow shaft concentrically arranged around the first shaft 24 and that can be rotatably built into the vehicle frame 3. The second shaft 27 is connected in a torsionally rigid manner to the front chain wheel 38.

An inner hollow shaft 39 is arranged between the first and the second shafts 24; 27. The inner hollow shaft 39 is supported by first roller bearings 40 on the first shaft 24 whereas the second shaft 27, that is also constructed as a hollow shaft, is supported by second roller bearings 41 on the inner hollow shaft 39. The planet wheel transmission comprises a first gear 42 firmly connected to the first shaft 24 and with an outside cogging, comprises several, e.g., three planet gears 43 rotatably connected so that they rotate with the inner hollow shaft 39 and which planet gears 43 are provided with a cogging, and comprises a second gear 44 firmly connected to the second shaft 27 and with an inside cogging, whereby the planet gears 43 are in engagement with the first and the second gears 42; 44.

In the drive mode, i.e., when the reverse gear mechanism 15 is disengaged, the inner hollow shaft 39 is connected to the first shaft 24 via the switching device 17 in a torsionally rigid manner (FIG. 9). The transfer of force takes place here from the first shaft 24 driven by the pedal drive 2 directly onto the second gear 44 and therewith onto the second shaft 27 via the inner hollow shaft 39 with the planet gears 43, which shaft 39 necessarily rotates together with the first gear 42 in the same direction.

In the braking mode, i.e., when the reverse gear mechanism 15 is engaged, the switching device 17 comes out of its engagement in the first shaft 24 so that the first shaft 24 can rotate relative to the inner hollow shaft 39. The switching device 17 is engaged in this position with a part 45 that is firmly connected to the vehicle frame 3 so that the inner hollow shaft 39 is connected in a torsionally rigid manner to the vehicle frame 3. Therefore, when the reverse gear mechanism 15 is engaged an oppositely directed direction of rotation is produced between the first and the second shafts 24; 27 by the planet gears 43. The pedal drive 2 is driven in the braking mode by the reverse gear mechanism 15 in the reverse direction so that an eccentric braking force can be exerted by the driver on the pedals 7.

Alternatively, a reverse gear mechanism 15 analogous to the one in FIG. 9 can be built into the second vehicle wheel 13, whereby the first shaft 24 is connected via the freewheel clutch 11 to the rear chain wheel 8 and the second shaft 27 is connected in a torsionally rigid manner to the wheel hub 35. The first shaft 24 is constructed as a hollow shaft and is rotatably supported on the second wheel axle 14 of the second vehicle wheel 13.

1. A vehicle with a pedal drive comprising:
a vehicle frame with a steering device;
a first vehicle wheel fastened by a first wheel axle on the steering device;
one or more second vehicle wheels that are fastened by at least one second wheel axle on the vehicle frame;
a braking device;
a drive device with a pedal crank that can be driven by pedals and with a chain drive, belt drive or Cardan drive arranged between the pedal crank and the at least one second vehicle wheel;
a freewheel clutch that is arranged on the at least one second vehicle wheel or on the pedal crank, wherein when the freewheel clutch is in a coupled-in state in a drive mode in a forward drive of the pedals a transfer of force is carried out from the drive device onto the at least one second vehicle wheel; and
a reverse gear mechanism that can be selectively engaged and disengaged, wherein when the reverse gear mechanism is engaged an oppositely directed direction of rotation can be produced between the at least one second vehicle wheel and the pedal crank;
wherein the freewheel clutch can be switched from the drive mode into a braking mode during the engaging of the reverse gear mechanism so that in the braking mode the pedal crank and the at least one vehicle wheel are connected to one another in a torsionally rigid manner.

2. The vehicle according to claim 1, wherein the freewheel clutch can be blocked or bridged in the braking mode.

3. The vehicle according to claim 1, wherein the braking device comprises a brake lever and upon an activation of the brake lever the freewheel clutch can be switched from the brake mode to the drive mode.

4. The vehicle according to claim 1, wherein the vehicle comprises an automatic overload safety by means of which the freewheel clutch can be shifted from the brake mode into the drive mode and the reverse gear mechanism can be disengaged.

5. The vehicle according to claim 1, wherein the vehicle further comprises an additional clutch.

6. The vehicle according claim 1, wherein the reverse gear mechanism comprises an intermediate wheel that can be engaged and disengaged.

7. The vehicle according to claim 1, wherein the reverse gear mechanism comprises a second chain or belt that is crossed between the pedal crank and the second vehicle wheel.

8. The vehicle according to claim 1, wherein the reverse gear mechanism comprises a planet wheel transmission.

9. The vehicle according to claim 1, wherein the vehicle comprises a brake-idling system that can be activated when the reverse gear mechanism is engaged and that brings about alternating braking-and idling modes of the pedal crank in the braking mode.

10. The vehicle according to claim 1, wherein the drive device or the reverse gear mechanism comprises a translation.

11. The vehicle according to claim 1, wherein the reverse gear mechanism is arranged on the pedal crank.

12. The vehicle according to claim 1, wherein the reverse gear mechanism is integrated into the at least one second vehicle wheel.

13. The vehicle according to claim 11, wherein the reverse gear mechanism comprises a first shaft with a longitudinal axis, drive means that comprise one or more chain wheels, belt wheels or elements of a Cardan drive, and comprises a second shaft that is constructed as a hollow shaft arranged concentrically around the first shaft, wherein the reverse gear mechanism is arranged between the first and the second shaft so that when the reverse gear mechanism is engaged an oppositely directed direction of rotation is produced between the first and the second shaft and when the reverse gear mechanism is disengaged a direction of rotation in the same direction is produced between the first and the second shaft.

14. The vehicle according to claim 13, wherein the first shaft is constructed as a hollow shaft and can be is built into the at least one second vehicle wheel.

15. The vehicle according to claim 1, wherein the vehicle comprises a measuring device for measuring the braking performance in the braking mode and further comprises a microcomputer.

16. The vehicle according to claim 1, wherein the vehicle comprises a switching device for cutting the reverse gear mechanism in and out.

17. The vehicle according to claim 1, wherein the freewheel clutch can be switched by a second switching device from the drive mode into the braking mode.

18. The vehicle according to claim 16, wherein the vehicle comprises an activation device with which the first and the second switching device can be activated.

19. The vehicle according to claim 1, wherein the vehicle comprises an electrodrive with which the vehicle can be driven in the forward direction.

20. The vehicle according to claim 19, wherein the electrodrive comprises a programmable microcomputer with which the driving force and/or the speed of the electrodrive can be adjusted.

21. The vehicle according to claim 19, wherein the vehicle comprises a power sensor by means of which the driving force of the electrodrive can be regulated.

22. The vehicle according to claim 19, wherein the electromotor can also be operated as a generator.

23. The vehicle according to claim 19, wherein an additional motor/generator group is arranged on the at least one second vehicle wheel.

24-25. (canceled)

26. A method for eccentric muscle training, comprising:
providing a vehicle according to claim 16;
driving the vehicle in a forward direction;
engaging the reverse gear mechanism by the switching device; and
braking the pedals moved in a retrograde direction by muscle power.

27. The method according to claim 26, wherein the driving of the vehicle in the forward direction takes place by downhill traveling.

28. The method according to claim 26, wherein the driving of the vehicle in the forward direction takes place by an electromotor.
